(19) United States
(12) Patent Application Publication
(10) Pub. No.: US 2006/0257053 A1
(43) Pub. Date: Nov. 16, 2006

(54) Segmentation and data mining for gel electrophoresis images

(76) Inventors: Alexandre J. Boudreau, Montreal, QC (CA); Patrick Dubé, Outremont (CA); Claude Kauffmann, Montreal (CA); Khaldoune Zine El Abidine, St-Laurent (CA)

Correspondence Address: BROMBERG & SUNSTEIN LLP, 125 SUMMER STREET, BOSTON, MA, 02110-1618, US

(21) Appl. No.: 10/563,706

(22) PCT Filed: Jun. 16, 2004
(86) PCT No.: PCT/CA04/00891

§ 371 Date: May 18, 2006

Related U.S. Application Data
(60) Provisional application No. 60/478,766, filed on Jun. 16, 2003.

(51) Int. Cl. G06K 9/54; G06K 9/00; G06K 9/46

(52) U.S. Cl. 382/305; 382/128; 382/190; 707/104.1

(57) ABSTRACT

A segmentation method is provided for the automated segmentation of spot-light structures into D images allowing precise quantification and classification of said structures and said images, based on a plurality of criteria, and further allowing the automated identification of multi-spot based patterns present in one or a plurality of images. In a preferred embodiment, the invention is used for the analysis of 2D gel electrophoresis images, with objective of quantifying protein expressions and for allowing sophisticated multi-protein pattern based image data mining, as well as image matching, registration, and automated classification.

The present invention provides a system and methods for the automated analysis and management of image based information. There is provided innovative image analysis (segmentation), image data-mining, and contextual multi-source data management methods that brought together provide a powerful image discovery platform.

### BACKGROUND

Image analysis and multi-source data management is increasingly becoming a problem in many fields, especially in the biopharmaceutical and biomedical industries where companies and individuals are now required to deal with vast amounts of digital images and various other types of digital data. With the advent of the human genome project and more recently the human proteome project, as well as with the major advancements in the field of drug discovery, the amount of information continues to increase at high rate. This increase further becomes a hurdle as fully automated systems are being introduced in a context of high throughput image analysis. Efficient systems for the analysis and management of this broad range of data are more then ever required. Although there have been many attempts in providing both analysis and management methods, few have or managed to integrate both technologies in an efficient and unified system. The major problems associated to the development of a unified discovery platform are mainly threefold: 1) the difficulty in developing robust and automated image segmentation methods, 2) the lack of efficient knowledge management methods in the field of imaging and the inexistence of contextual knowledge association methods, and 3) the development of truly object based data-mining methods.

The present invention simultaneously addresses these issues and brings forth a unique discovery platform. As opposed to standard image segmentation and analysis methods, the herein described embodiment of 2D Gel Electrophoresis image analysis describes a new method that allows fully robust and automated segmentation of image spots. Based on this segmentation method, object-based data-mining and classification methods are also described. The main system provides means for the integration of these segmentation and data-mining methods in conjunction to efficient contextual multi-source data integration and management.

Some basic methods have been previously developed for the purpose of spot segmentation within 2D images (4,592,089) but do not provide automated methods and therefore do not eliminate the errors and variability introduced by manual segmentation. More recent software applications have been developed by companies for the analysis of 2D gel electrophoresis images that do provide some degree of automation (e.g. Phoretix). However, these software do not appropriately address the critical issues of low expression spots, spot aggregations and image artifacts. Without proper consideration of these issues, the provided software produce biased and non precise results, which considerably reduces the usefulness of the methods.

Some attempts were also made in providing methods for the data-mining of images (5,983,237; 6,567,551; 6,563,959). These methods are however exclusively feature-based, meaning that the searching of images is achieved by looking for images with similar global features such as texture, general edges and color. However, this type of image content data-mining does not provide any method for the retrieval of images from criteria that are based on precise morphological or semantic attributes of precisely identified objects of interest.

The herein disclosed invention may relate and refer to a previously filed patent application by assignee that discloses an invention relating to a computer controlled graphical user interface for documenting and navigating through a 3D image using a network of embedded graphical objects (EGO). This filing has the title: METHOD AND APPARATUS FOR INTEGRATIVE MULTISCALE 3D IMAGE DOCUMENTATION AND NAVIGATION BY MEANS OF AN ASSOCIATIVE NETWORK OF MULTIMEDIA EMBEDDED GRAPHICAL OBJECTS.

### SUMMARY

In one embodiment of the invention, a first aspect of the invention is the innovative segmentation method provided for the automated segmentation of spot-like structures in 2D images allowing precise quantification and classification of said structures and said images, based on a plurality of criteria, and further allowing the automated identification of multi-spot based patterns present in one or a plurality of images. In a preferred embodiment, the invention is used for the analysis of 2D gel electrophoresis images, with objective of quantifying protein expressions and for allowing sophisticated multi-protein pattern based image data-mining as well as image matching, registration, and automated classification. Although the present invention describes the embodiment of automated segmentation of 2D images, it is understood that the image analysis aspect of the invention can be further applied to multidimensional images.

Another aspect of the invention is the contextual multi-source data integration and management. This method provides efficient knowledge and data management in a context where sparse and multiple types of data need to be associated with one another, and where images remain the central point of focus.

In a preferred embodiment, every aspect of the invention is used in a biomedical context such as in the healthcare, pharmaceutical or biotechnology industry.

### BRIEF DESCRIPTION OF THE DRAWINGS

The invention will be described in conjunction with certain drawings which are for the purpose of illustrating the preferred and alternate embodiments of the invention only, and not for the purpose of limiting the same, and wherein:

FIG. 1 displays the overall image spot analysis and segmentation method flow.

FIG. 2 displays the basic sequence of operations in the process of image analysis and contextual data integration.

FIG. 3 depicts the basic sequence of operations required by the data-mining and object-based image discovery process.

FIG. 4 depicts an example of standard multi-source data integration.

FIG. 5 depicts an embodiment of the contextual multi-source data integration as described in the current invention.

FIG. 6 is a sketch of the interactive ROI selection.

FIG. 7 depicts another means for visually indicating contextual data integration.

FIG. 8 displays the basic operations involved in the extraction of spot parameters for automated spot picking.

FIG. 9 displays the general flow of operations required in contextual data association

FIG. 10 depicts the basic image analysis operational flow.

FIG. 11 depicts an embodiment of the data-mining results display.

FIG. 12 depicts another embodiment of data-mining results display.

FIG. 13 depicts a surface plot of the simulated spot objects in comparison to the true objects.

FIG. 14 is an example of a multi-spot pattern.

FIG. 15 depicts example source and target patterns used in the process of image matching.

FIG. 16 depicts a hidden spots parental graph.

FIG. 17 a-FIG. 17 c depict two-scale energy profiles for noise and spots.

FIG. 18 illustrates a basic neural network based classifier.

FIG. 19 depicts the steps involved in the spot confidence attribution process.

FIG. 20 depicts the steps involved in the smear and artifact detection process.

FIG. 21 depicts the basic steps involved in the hidden spot identification process.

FIG. 22 a displays a raw image.

FIG. 22 b displays the superimposed regionalization.

FIG. 22 c displays an example hidden spot identification.

FIG. 23 displays a profile view of a multiscale event tree.

FIG. 24 displays a 3D view of a spot's multiscale event tree.

FIG. 25 displays a multiscale image at different levels.

FIG. 26 displays typical image variations including noise and artifacts.

FIG. 27 displays the overall steps involved in the spot identification process.

Referring numerals comprised in the figures are here forth mentioned in the detailed description within brackets such as: (2).

### DETAILED DESCRIPTION

Main System Components

The main system components manage the global system workflow. In one embodiment, the main system is composed of five components:
1. Display Manager: manages the graphical display of information;
2. Image Analysis Manager: Loads the appropriate image analysis module allowing for the automated image segmentation;
3. Image Information Manager: manages the archiving and storage of the images and their associated information.
4. Data Integration Manager: manages the contextual multi-source data integration;
5. Data-Miner: permits complex object based image data-mining.

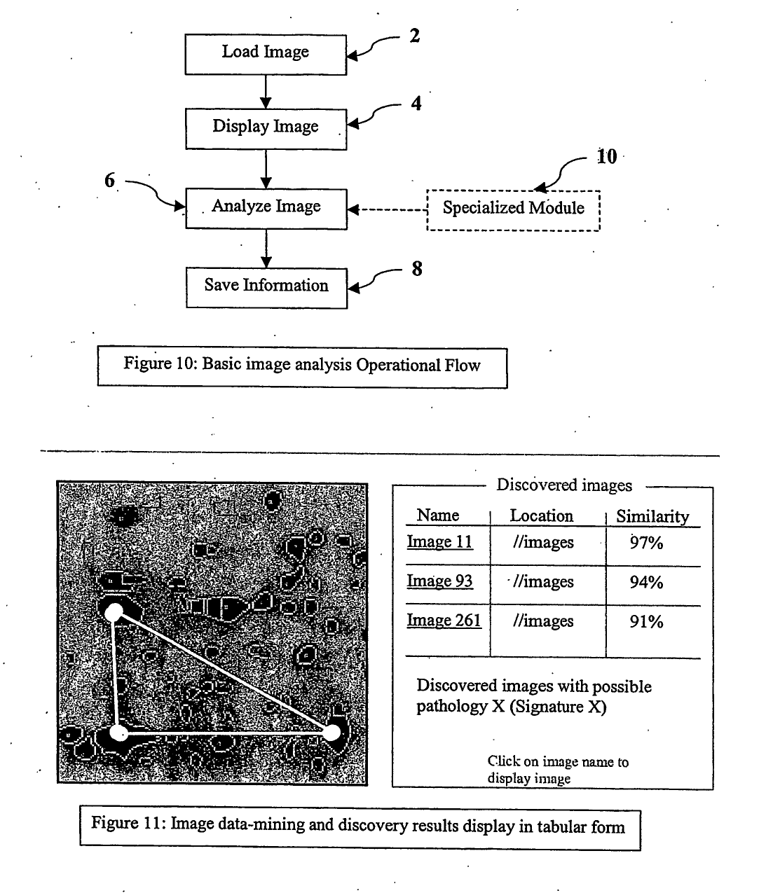

Referring to FIG. 10, in a first step, a digital image can be loaded by the system from a plurality of storage media or repositories, such as, without limitation, a digital computer hard drive, CDROM, or DVDROM. The system may also use a communication interface to read the digital data from remote or local databases. The image loading can be a user driven operation or fully automated (2). Once a digital image is loaded in memory, the display manager can display the image to the user (4). The following step usually consists in analyzing the considered image by a specialized automated segmentation method through the image analysis manager (6). In a specific embodiment the user interactively indicates the system to analyze the current image. In another embodiment, the system automatically analyzes a loaded image without user intervention. Following the automated analysis of the image, the image information manager automatically saves the information generated by the automated analysis method in one or a plurality of repositories such as, but without limitation, a relational database (8). The herein described system provides automatic integration of specific modules (plugins) allowing to dynamically load and use a precise module. Such modules can be for the automated image analysis, where a particular module can be specialized for a specific problem or application (10). Another type of module can be for specialized data-mining functionalities.

Following these basic steps, it becomes possible to display relevant contextual information within the image, associate multi-source data to specific objects within the image (or the entire image) and perform advanced data-mining operations.

Once the considered image has been automatically segmented, the display manager can display the segmented objects in many ways so as to emphasize them within the image, such as, without limitation, rendering the object contours or surfaces in distinctive colors. Another type of contextual display information is the representation of visual markers that can be positioned at a specific location within the image so as to visually identify an object or group of objects as well as to indicate that some other data for (or associated to) the considered object(s) is available.

The data integration manager allows for users (or the system itself) to dynamically associate multi-source data stored in one or a plurality of local or remote repositories to objects of interest within one or a plurality of considered images. The association of external data to the considered images is visually depicted using contextual visual markers within or in the vicinity of the images.

The Data-Miner allows for advanced object-based data-mining of images based on both qualitative and quantitative information, such as user textual descriptions and complex morphological parameters, respectively. In combination with the data integration manager and the display manager the system provides efficient and intuitive exploration and validation of results within the image context.

Contextual Multi-Source Data Integration

The contextual multi-source data integration offers a novel and efficient knowledge management mechanism. This subsystem provides a means for associating data and knowledge to a precise context within an image, such as to one or a plurality of objects of interest therein contained, as well as to visually identify the associations and contextual locations. A first aspect of the contextual integration allows for efficient data analysis and data-mining. The explicit association between one or a plurality of data with one or a plurality of image objects provides a highly targeted analysis and mining context. Another aspect of this subsystem is the efficient multi-source data archiving providing associative data storage and contextual data review. In opposition to traditional multi-source data integration methods where for instance an entire image will be associated to external data, the current subsystem allows a user to readily identify to what specific context the data refers to and therefore provides a high level of knowledge. For instance, in a context where external data refers to three specific objects within an image containing a large number of segmented or non segmented objects, the contextual association allows a user to immediately view to which objects the data relates to and therefore visually appreciate both content in association. Without this possibility, the integration of external multi-source data is basically rendered useless.

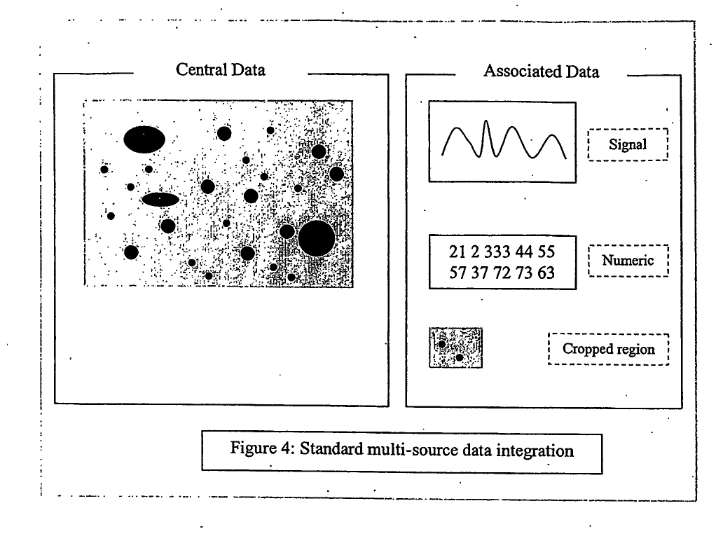

FIG. 4 depicts a case where no contextual data association is provided, illustrating the difficulties and problems it causes, as it is impossible to identify to which objects in the image the data refers to.

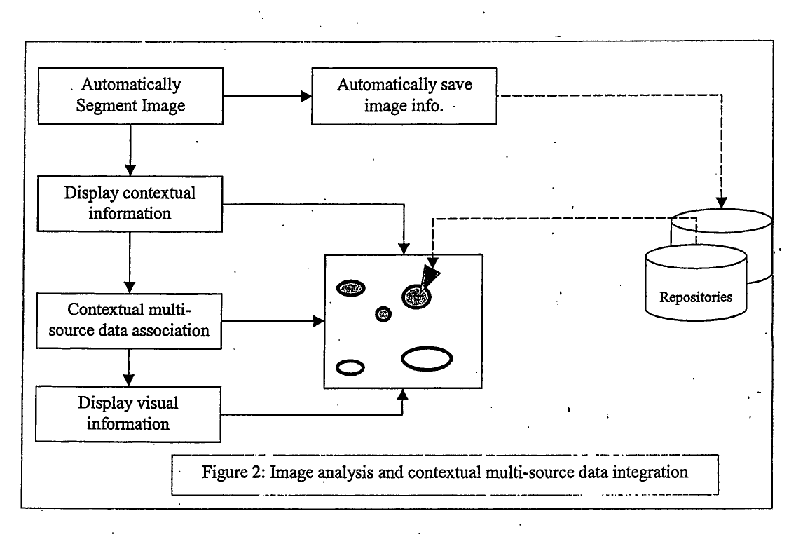

Referring to FIG. 2, in one embodiment, the current subsystem (associated to the data integration manager) comprises the following steps:

Selection of one or a plurality of regions of interest;

Visual contextual marking;

Data selection;

Contextual data association;

Information archiving.

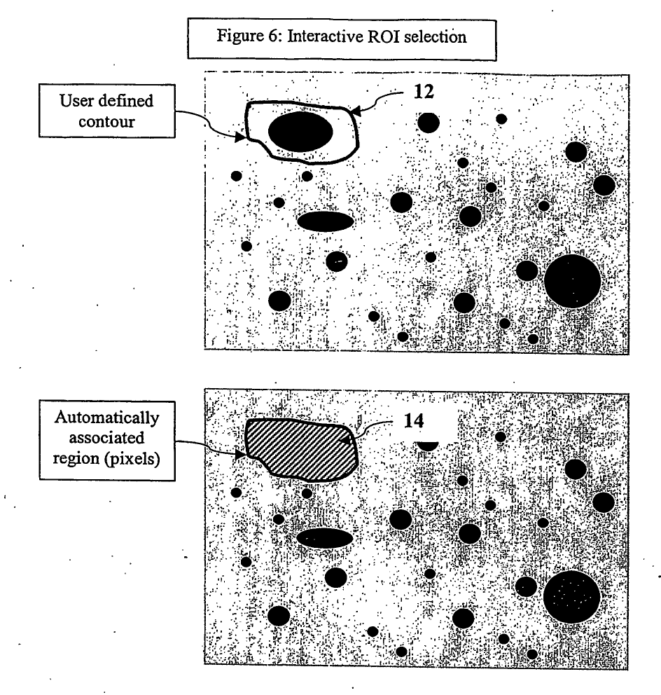

Selecting regions of interest. The first step consists in identifying one or a plurality of regions of interest within one or a plurality of considered source images. The latter are the initial point of interest to which visual information and external data can be associated. The identification and production of a region of interest can be achieved both automatically, using a specialized method, and manually, through user interaction. In the first case, the automatic identification and production is achieved using automated image analysis and segmentation methods. In one embodiment, the regions of interest are spot-like structures and are identified and segmented using the herein defined image analysis and segmentation method. In such case, amongst the pool of identified regions of interest (objects) it is possible to select one or a plurality of specific objects, also in an automated manner, based on a specified criteria. For instance, the method can select every object that has surface area above a specified threshold and define the latter as the regions of interest. On the other hand, the interactive selection of regions of interest can be achieved in many ways. In one embodiment, following the automated image segmentation process, the user interactively selects the specific regions of interest. This can be achieved by clicking in the region of the image where a segmented object is positioned and that is to be defined as a region of interest. This selection process uses a picking method, where the system reads the coordinate at which the user clicked and verifies if this coordinate is contained in the region of a segmented object. The system can thereafter emphasize the selected object using different rendering colors or textures. Referring to FIG. 6, yet another method for interactively selection a region of interest consists in manually defining a contour within the image (12). The user uses a control device such as a mouse to interactively define the contour by drawing directly on the monitor. The system then takes the drawn contour's coordinates and selects every pixel in the image that is contained within the boundary of the contour (14). The selected pixels become the region of interest. This method is used when no automated segmentation methods are provided or used.

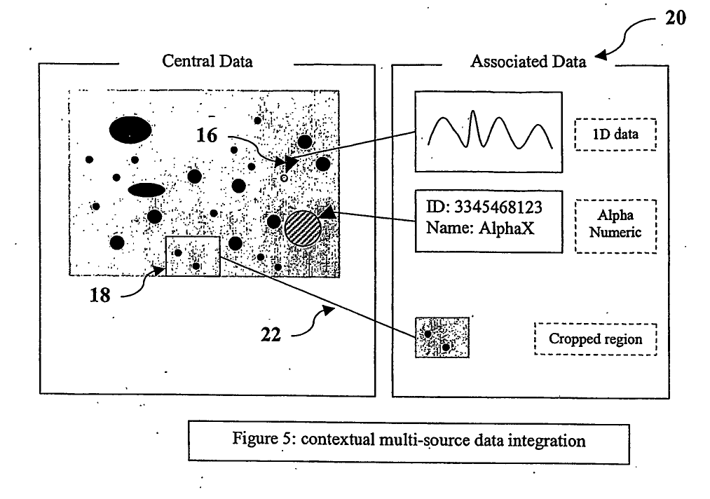

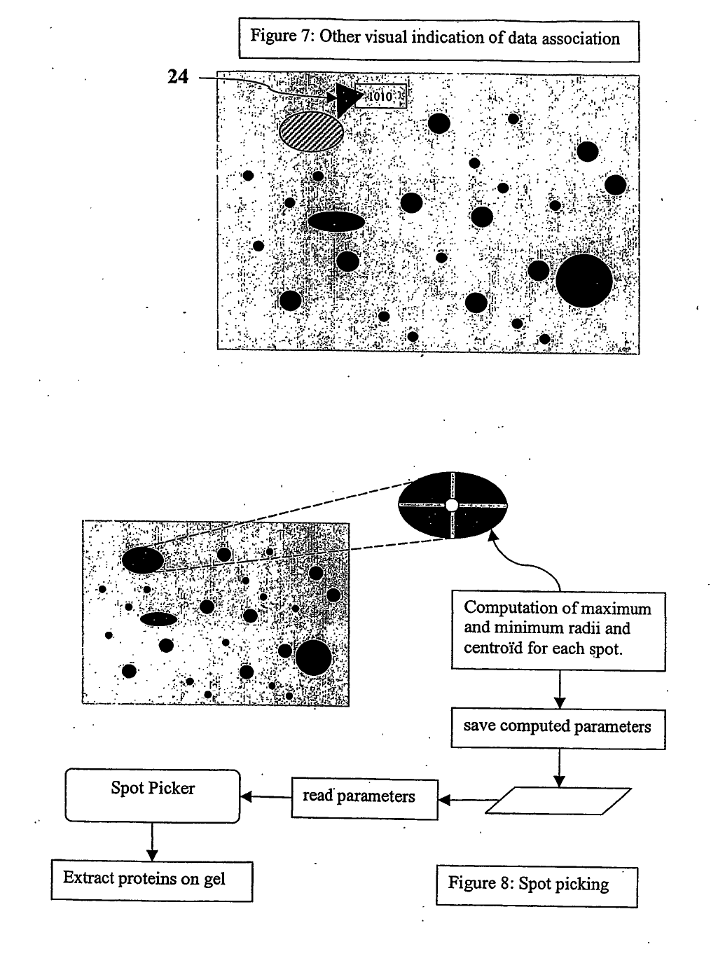

Visual contextual marking. Referring to FIG. 5. The visual contextual marking step consists in displaying a graphical marker or object within the image context itself as well as in the vicinity of the image. This provides a visual indication about what are the selected regions of interest within the image and whether there is any information/data in association to this specific region of interest. With this mechanism, users can readily view to which specific regions the external data refers. The graphical markers and objects can be of many types, such as a graphical icon positioned on or adjacent to the region of interest (16), or it can be the actual graphical emphasis of the region displayed using a colored contour or region (18). The marking process simply requires the system to take the coordinates of the previously selected regions of interest and display graphical markers according to these coordinates. Besides visually identifying the regions of interest within the image, the marking allows for the direct and visual association of these regions with associated external data. In one embodiment, part or the entirety of the external data is displayed in a portion of the display (20) and a graphical link is displayed between the data and their specific associated regions of interest (22). Referring to FIG. 7, in another embodiment, a graphical marker has a graphical representation that allows the user to see that this region has some external data associated to it, without displaying the associated data or a link to the latter (24). In such case, the user may choose to view the associated data by activating the marker such as by clicking on it using the control device. The graphical markers can be manually or automatically positioned. When automatic identification and selection of regions of interest is performed, the system can further automatically create and display a graphical marker in the vicinity of the region, allowing for eventual data association. In another embodiment, when a user selects the region of interest by interactively drawing a contour on the display, the system thereafter automatically creates and displays a graphical marker in the vicinity of this newly defined region. In yet another embodiment, the user selects an option and interactively positions a graphical marker in a chosen image context.

Data Selection. Following the previously defined steps, external data can now be associated to the image in its entirety as well as to specific regions of interest. In a preferred embodiment, the system provides a user interface for interactively selecting the external data that is of interest. The interface provides the possibility of selecting data in various media, such as folder repositories or databases.

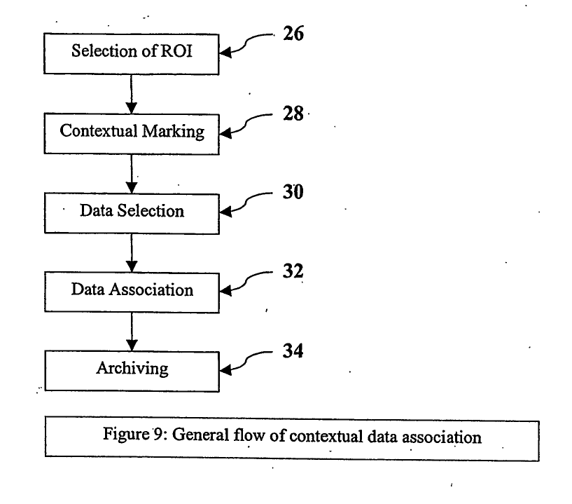

Contextual Data Association. In a preferred embodiment, the user interactively chooses one or a plurality of the selected data to be associated to one or a plurality of the selected regions of interest. This association can be done for instance by clicking and dragging the mouse from a graphical marker to the considered data. In this specific embodiment, the external data is displayed in the monitor, from which the user creates an associative link. The association process creates and saves a data field that directly associates the region of interest or a graphical marker to the considered external data. This data field can be for instance the location of both source and external data so that when a user returns on a project that integrates associative information, it will be possible to view both the external data and the visual association. In one embodiment, the visual association is displayed using a graphical link from the marker to the data. In another embodiment, the association is depicted by a specific graphical marker, without the need for visually identifying associations to external data. In this context, the marker is required to be activated to view some or all of the information associated to it. In a specific embodiment, the external data is embedded in the graphical marker, said marker forming a data structure with a graphical representation, in which case the data is stored in the marker database, wherein each entry is a specific marker. The contextual data association mechanism can also be applied in both source and external data, i.e., the external data associated to a specific region of interest can be itself a region of interest within another image or data. To do so, the herein described contextual multi-source data integration subsystem can be directly applied to the external information. Referring to FIG. 9, the overall contextual data association process requires the selection of a region of interest (26) followed by the positioning of a graphical marker to an object or region of interest within the image (28). At that point, external data can be selected (30) and associated (32) to the graphical marker. The steps of 30 and 32 can be performed before or after step 26. The final step consists in saving the information (34).

Information Archiving. The final step consists in storing the information and meta-information in a repository. In order to allow the return on the information along with all the associated multi-source data, the system automatically saves every meta-information required to reload the data and display every graphical elements. In a preferred embodiment, the meta-information is structured, formulated, and saved in XML. The meta-information comprises, without limitation, a description of: the source image(s), the external data, the regions of interest, graphical markers, and associative information.

Image Analysis and Data-Mining

The following methods are described in relation to the previously defined general system architecture, more specifically relating to the image analysis manager and the data-miner. These methods are however novel by themselves, without association to the herein described main system.

In the preferred embodiment of 2D gel electrophoresis image analysis, the following methods are provided for the detection of spots within the images as well as for the image data-mining and classification.

Spot Detection

A first aspect of the system is the automated spot detection. This component takes into account multiple mechanisms, including without restriction:
Noise Representation
Spot Representation
Scale Identification
Noise Characterization
Object Characterization
Unbiased Regionalization
Spot Identification

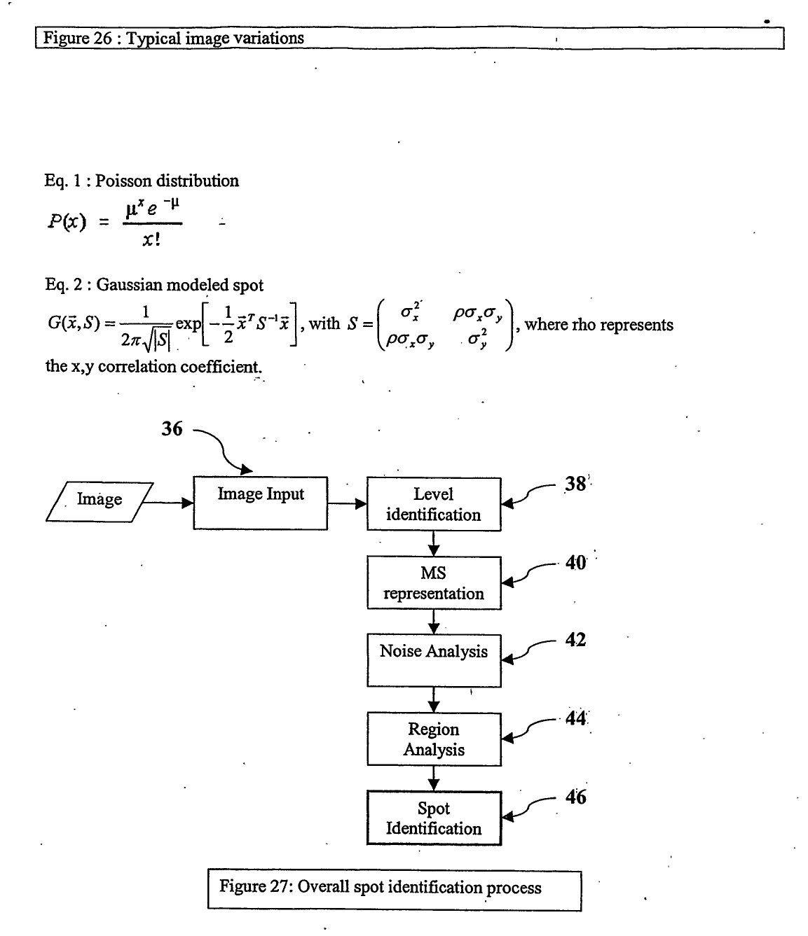

In order to intelligently analyze the images it is essential to fully understand their nature and properties. In a specific embodiment, the considered images are a digital representation of 2D electrophoresis gels. These images can be characterized as containing an accumulation of entities such (FIG. 26):
Protein spots of variable size and amplitude
Isolated spots
Grouped spots
Artifacts (dust, finger prints, bubbles, rips hair . . . )
Smear lines
Background noise

By precisely modeling the noise that can be present in images it becomes possible to differentiate true objects of interest from noise aggregations in subsequent analyses. Although noise distributions and patterns may vary from one image to another, it is possible to model it according to a specific distribution depending on the type of image being considered. In the embodiment considering 2D gel electrophoresis images, the noise can be precisely represented by a Poisson distribution (Equation 1).

Similarly to the representation of noise, spots can be modeled according to various equations which either mimics the physical processes that created the spots or that visually correspond to the considered objects. In most cases, a 2D spot can be represented as a 2D Gaussian distribution, or variants thereof. To precisely model the spots, it may be required to introduce a more complex representation of a Gaussian, so as to allow the modeling of isotropic and anisotropic spots, of varying intensity. In a specific embodiment, this is achieved using Equation 2.

Referring to FIG. 27, the spot detection operational flow consists of the following steps:

1. Image input (36)

2. Identification of optimal multi-scale level (38)

3. Multiscale image representation (40)

3. Noise characterization and statistical analysis (42)

4. Region analysis (44)

5. Spot identification (46)

The image input component can use standard I/O operations to read the digital data from various storage media, such as, without limitation, a digital computer hard drive, CDROM, or DVDROM. The component may also use a communication interface to read the digital data from remote or local databases.

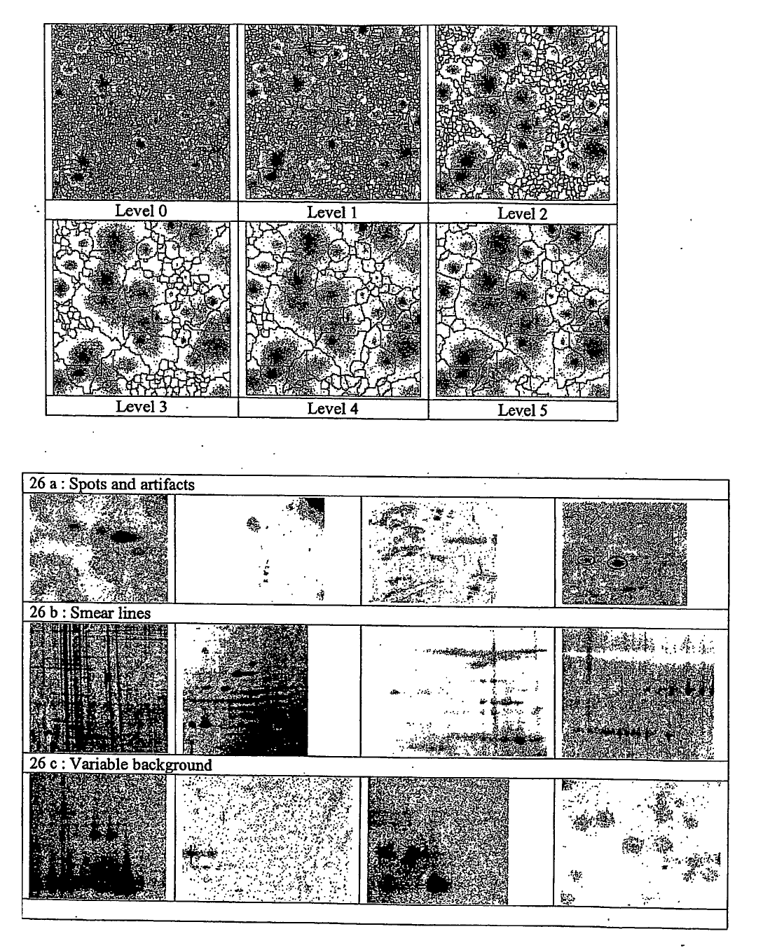

Once the digital image is input by the system, the first step consists in identifying the optimal multi-scale level that should be used by the image analysis components, wherein the said level corresponds to the level at which noise begins to aggregate. To identify this level, the image is partitioned in distinct regions and the process is successively repeated at different multi-scale levels. A multi-scale representation of an image can be obtained by successively smoothing the latter with an increasing Gaussian kernel size, wherein at each smoothing level the image is regionalized. It is thereafter possible to track the number of region merge events from one level to another, which dictates the aggregation behavior. The level at which the number of merges stabilizes is said to be the level of interest. The regionalization of the image can be achieved using a method such as the Watershed algorithm. FIG. 25 illustrates an image regionalized at different multi-scale levels using the Watershed algorithm.

Once the level is identified, a multi-scale representation of the image is kept in memory along with its regionalized counterpart. From there, the system proceeds with the characterization of the noise by means of a function such as the Noise Power Spectrum. The NPS can be computed using the first two levels of a Laplacien pyramid. From this function, it is possible to obtain the image's statistical characteristics, such as, without limitation, its Poisson distribution. Thereafter, a multi-scale synthetic noise image is generated so as to quantify the noise aggregation behavior. As previously described, the multi-scale noise image is obtained by successively smoothing the synthetic image with a Gaussian kernel of increasing size; up to the previously identified level. At the last level, the multi-scale noise image is regionalized with the Watershed algorithm. This simulated information can hereafter be used to identify similar noise aggregation behaviors in the spot image and therefore discriminate noise aggregations from objects of interest.

The following step consists in analyzing each region in the multi-scale regionalized image in order to detect spots and eliminate noise aggregation regions. The objective is mainly to identify regions of interest that are not noise aggregations. The spot identification can be achieved using a plurality of methods, some of which are described below. These methods are based on the concept of signature; wherein a signature is defined as a set of parameters or information that uniquely identify objects of interest from other structures. Such signatures can be for instance based on morphological features or multi-scale events patterns.

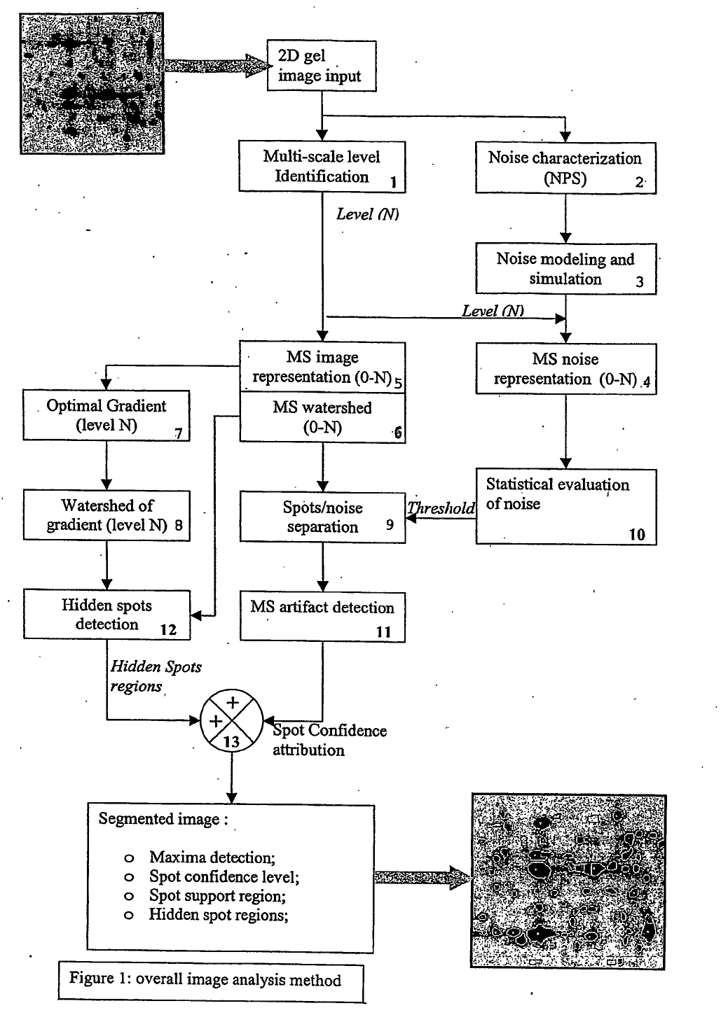

The overall image analysis and spot segmentation method flow is depicted in FIG. 1.

Multi-Scale Event Trees

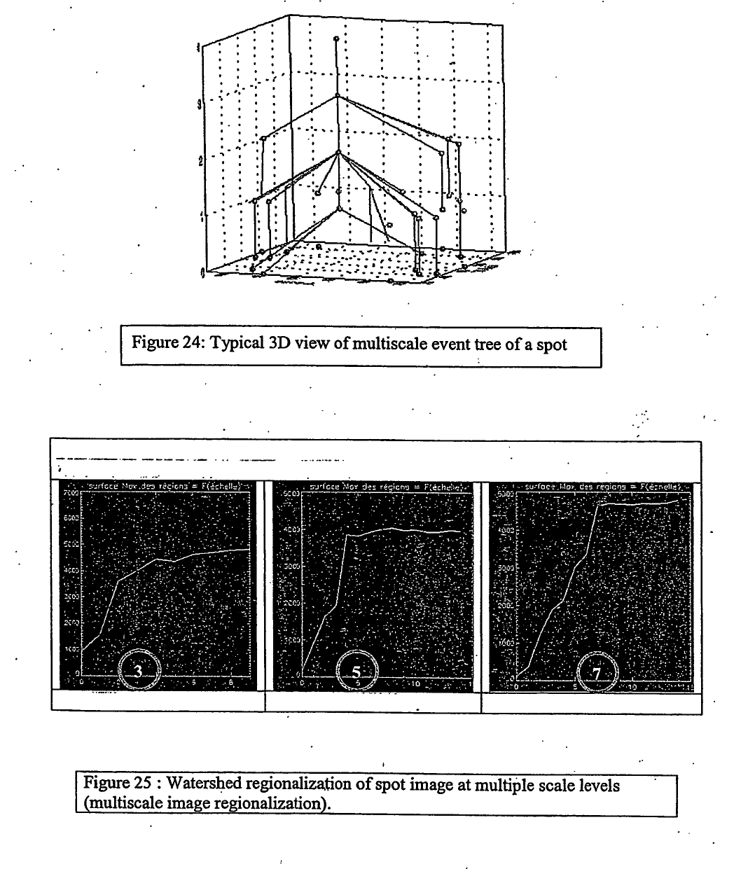

A multi-scale event tree is a graphical representation of the merge and split events that are encountered in a multi-scale representation of an image. Objects at a specific scale will tend to merge with nearby objects at a larger scale, forming a merge event. A tree can be built by recursively creating a link between a parent region and its underlying child regions. A preferred type of data structure used in this context is an N-ary tree. FIG. 23 depicts a multiscale event tree. FIG. 24 further illustrates a Multiscale event tree of a spot region. From this tree, a plurality of criteria can be used to evaluate whether the associated region is an object of interest. Since noise is characterized by its relatively low persistence in the multi-scale space and by its aggregation behavior, it is possible to readily identify a noise region based on its multi-scale tree. For instance, there will be no persistent main tree path (“trunk”). A multi-scale tree based signature can contain information such as, but without limitation:

The mean distance of a minimum, with respect to the tree root expressed at a level N

Variance of the distance with respect to the root

Number of Merge events at each scale level

Variance on the surface of each region along the main tree path

Volume of regions along main tree path

Classification

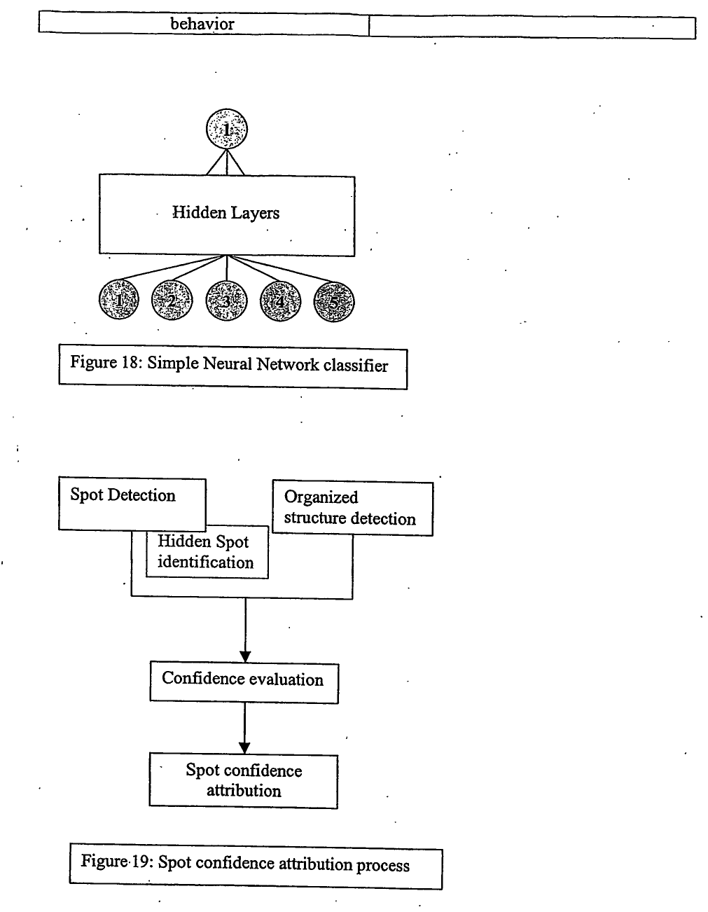

From the perspective of signature-based characterization of spots, it becomes possible to make use of various classification methods to properly identify objects of interest. Using the previously mentioned signature variables, it is possible to form an information vector that can be directly input to various neural networks or other classification and learning methods. In a specific embodiment, classification is achieved using a multi-layer Perceptron neural network. Referring to FIG. 18, a possible network configuration could comprise a 5 neurons input which map directly to the 5 element vector associated to the above described signature. The neural network's output can be of binary nature, with a single neuron, wherein the classification is of nature “spot”/“not spot”. Another configuration could comprise a plurality of neurons in output to achieve classification of a signature amongst a plurality of possible classes.

Two-Scale Energy Amplitude

Another method we have developed, based on the concept of multi-scale graph events, for the identification of spots amongst other structures, consists in evaluating the differential normalized energy amplitude of a region expressed at two different multi-scale levels; level 1 and level N (FIG. 17). By normalizing the differential energy of objects according to the object of maximum energy, a comparison base is built, allowing the subsequent identification of objects of interest. With this information and from the a priori knowledge that objects emerging from noise or artifacts have a large differential energy, it is possible to clearly identify the objects of interest (spots) which have an inherent diffusive expression (FIG. 17.c), as opposed to noise regions that are most commonly expressed as impulses in space (FIG. 17.b).

Hidden Spots Identification

Due to spot intensity saturation and the aggregation of a plurality of spots, certain regions of interest that contain a spot can be misidentified. This phenomenon is based on the principles that no minima can be identified in saturated regions, and hence no objects can be identified, and that only a single minimum will commonly be identified in regions containing aggregated spots. To overcome these difficulties the system integrates a component specifically designed to detect regions containing saturated spots or an aggregation of spots. In the preferred embodiment of 2D gel electrophoresis images, protein expressions on the gel are characterized by a cumulative process wherein each protein has its own expression level, which overall translates to the fact that only a single protein amongst the grouping will have an expression maximum. This cumulative process will generate clusters of protein with a plurality of hidden spots.

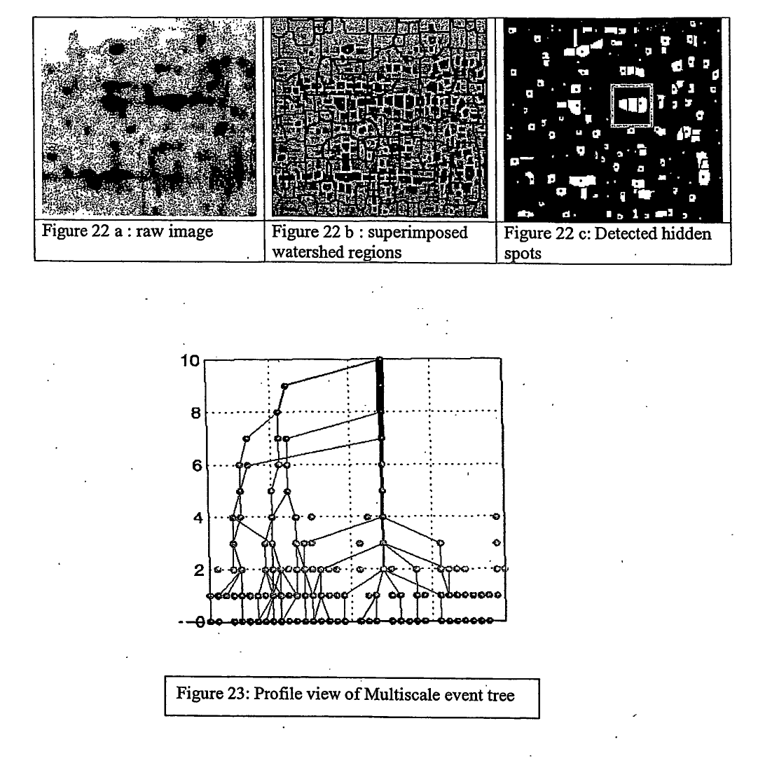

Referring to FIG. 21, the hidden spot identification process consists in first regionalizing the image with the Watershed algorithm (48) and thereafter applying a 2nd watershed-based method that regionalizes the image according to an optimal gradient representation (50). This optimal gradient representation will in most cases allow the efficient separation of aggregated spots. The next step consists in evaluating the concurrence of regions obtained by both regionalization methods (52). Regions obtained by the gradient approach that are contained in the basic watershed region have a probability of being hidden spots. FIG. 22 illustrates the concurrent regionalization and hidden spot identification.

Hidden Spots Analysis

The analysis of spot regions at a scale level N may in some cases create what we call false hidden spots. The latter are true spots that have been fused with a neighboring spot at scale level N, causing the initially true spot to lose its extremum expression at the level N. When such a spot no longer has an identifiable extremum, the regionalization process, using a watershed algorithm for instance, cannot independently regionalize the spot. The latter is therefore aggregated with its neighbor causing it be identified as a hidden spot by the herein described algorithm. To surpass this problem, we introduce a multiscale top-down method that detects whether a hidden spot actually has an identifiable extremum in inferior scale levels. The method comprises the following steps: For every spot region that contains one or a plurality of hidden spots, first approximate an extremum location within the region at level N of each of its hidden spots, then iteratively go to a lower scale level to verify if there exists an identifiable extremum in the vicinity of the approximated location, if there is a match, force the level N to have this extremum, and finally recompute a watershed regionalization of the top region to generate an independent region for the previously hidden spot. This mechanism allows us to automatically define the spot region of the previously hidden spot and therefore allow for precise quantification of this spot.

Organized Structure Detection

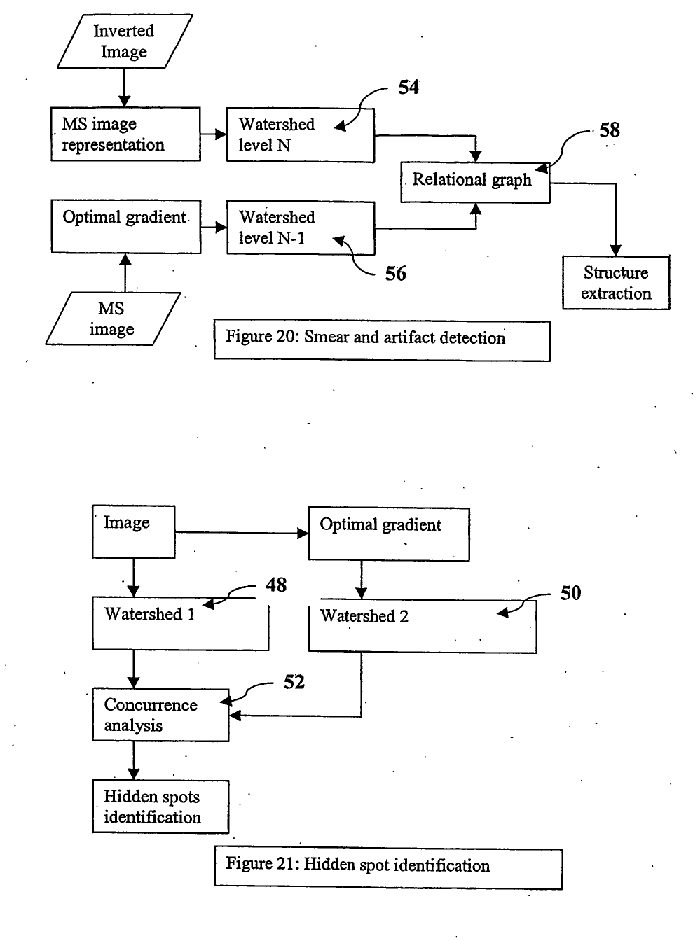

The second main component in the overall system consists in the detection of organized structures in the image. In the embodiment of 2D gel image analysis, these structures include smear lines, scratches, rips, and hair, just to name a few. Referring to FIG. 20, the first step in the component's operational flow is to regionalize the level N of a multi-scale representation of the image with inverted intensities using the watershed method (54). The objective is to create regions based on the image's ridges. The second step consists in regionalizing the gradient image at level N-1 of the multi-scale, again using the watershed algorithm (56). Once both regionalized representations have been computed, the following step is to build a relational graph of the regions based on their connectivity, wherein each region is associated to a node (58). The final step consists in detecting graph segments that have a predefined orientation and degree of connectivity, topology, and semantic representation. For instance, intersecting vertical and horizontal linear structures can correspond to smear lines, whereas curved isolated structures can be associated to hair or rips in the images.

Confidence Attribution

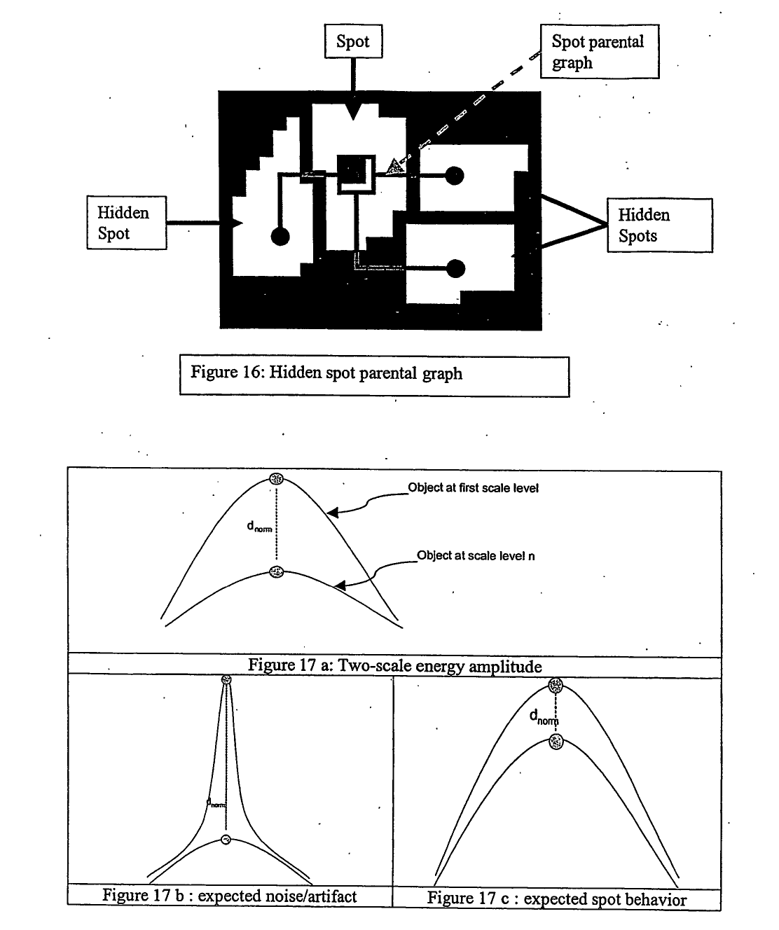

Following the spot, hidden spot, and organized structure detection processes, enough information is at hand for the system to intelligently attribute a confidence level on the detected spots. Such a level specifies the confidence at which the system believes the detected object is truly a spot and not an artifact or noise aggregation object. On one hand, by following the statistical analysis of the noise in the image, it is possible to precisely identify objects that have a similar statistical profile and distribution as the noise aggregations, and hence attribute these objects a low confidence level, if they have not already been eliminated by the system. For instance, if an object is identified as a spot but has differential energy amplitudes very similar to noise aggregations, then this object would be attributed a low confidence level. Furthermore, the organized structure detection process brings additional information and provides a more robust approach to attributing confidence levels. Such additional information is critical since in certain situations there are objects that have a similar distribution and behavior as spots, but actually originate from artifacts and smear lines for instance. In the embodiment of 2D gel image analysis, there is a notable behavior where the crossing of vertical and horizontal smear lines creates an artificial spot. By previously detecting the smear lines in the image, we are able to identify overlapping smears and hence identify artificial spots. In the same way, spots that are in the vicinity of artifacts and smear lines may be attributed a lower confidence, as their signatures may have been modified by the presence of other objects, meaning that the intensity contribution of the artifacts can cause a noise aggregation object to have a similar expression as true spots. Furthermore, following the hidden spot detection process, a parental graph of the hidden spots can be built with respect to the spot contained in the same region. This parental graph can be used to assign the hidden spots a confidence level in proportion to their parent spot that has already been attributed a confidence (FIG. 16). Overall, the confidence attribution component precisely attributes a level to each spot based on the computed statistical information and the detected structures in their vicinity. The overall process is depicted in FIG. 19.

Spot Quantification

In the embodiment of 2D gel electrophoresis, as it may also be the case for other embodiments, the physical process of spot formation may introduce regions where spots partially overlap. This regional overlap causes a spot to be possibly over quantified as its intensity value may be affected by the contribution of the other spots. To counter this effect, the current invention provides a method for the modeling of this cumulative effect in order to precisely quantify independent spot objects. The method consists in modeling the spot objects with diffusion functions, such as 2D Gaussians, and thereafter finding the optimal fitting of the function on the spot. For each spot, the steps comprise

Computing a first approximate diffusion function to be fit.

Finding optimal parameters using a fitting function such as a Least Square approach.

Once the functions have been optimally fit, the system simulates the cumulative effect by adding the portions of each of the functions that represent overlapping spots. If the simulated cumulating process resembles that of the image profile, then each of the functions correctly quantify their associated spot objects. The spots can thereafter be precisely quantified with their true values without this cumulative effect by simply decomposing the added functions and quantify the independent functions.

In this method, the height of the diffusion functions correspond to the intensity values of the corresponding pixels in the image, as these intensities can be taken as a projection value to build a 3D surface of the image. FIG. 13 depicts the simulated diffusion functions (72) in correspondence to the image's surface of the associated spot objects (70). These diffusion functions can thereafter be used to precisely quantify the spot objects, such as their density and volume. The width and height of the function provide the information needed to quantify the spot objects. This method is of tremendous value in the embodiment of 2D gel electrophoresis analysis wherein precise and robust protein quantification is of great importance.

Spot Picking

Referring to FIG. 8, another aspect of the system in the embodiment of 2D gel electrophoresis analysis relates to the automated excision of proteins within the gel matrices. The herein described image analysis method provides the means for automatically defining the spatial coordinates of the proteins that should be picked using a robotic spot picking system. Following the segmentation of the spot structures in one or a plurality of images, the system generates a set of parameters. These parameters can comprise for each spot, without limitation: centroid (center of mass) coordinate, mean radius, maximum radius, minimum radius. This information can be directly saved in a database or in a standardized file format. In one embodiment, this information is saved using XML. By offering a wide range of parameters in a self-explainable standard format, our system can be used by any type of robotic equipment. Furthermore, based on the herein described spot confidence attribution, the system provides the possibility of selecting a preferred confidence for spot picking. With this, it is possible to only pick proteins that have a confidence level higher than a certain level, higher than 50% for instance. The overall steps required in the spot picking process are:

1. Automated segmentation of image;

2. Automated extraction of parameters;

3. Automated storing of parameters.

Multi-Spot Processing

Multi-spot processing brings forth the concept of object based image analysis and processing. In the herein described invention, the term multi-spot processing refers to spot (object) based image processing operations, wherein the operations can be of various nature, including, without limitation, the use of a plurality of spots and therein emerging patterns for automated and precise object based image matching and registration in a one-to-one or one-to-many manner. Another type of operation that is explicitly referred to by the invention is the possibility to perform object based image data-mining and classification, also called object-based image discovery. As opposed to current content-based image data-mining methods that simply extract basic image features such as edges and ridges for subsequent data-mining, the current invention provides a means for mining a plurality of images based on topological and/or semantic object based information. Such information can be the topological and semantic relation of a plurality of identified spots in an image, forming an enriched spot pattern.

Image Matching

In the preferred embodiment of 2D gel electrophoresis image analysis, image matching is of prime importance. The herein described method provides a means for matching one or a plurality of target images with a reference image in an automated manner using an object-centric approach. The matching method comprises the following steps:

1. Automated spot identification and segmentation

2. Reference image patterns creation

3. Target image(s) patterns identification

4. Spot-to-Spot match

The automated spot identification and segmentation is achieved using the spot identification method described in this invention. This first step is critical in the overall image matching process, as the robustness of the spot identification dictates the quality of matching. Spot identification errors will cause multiple mismatches in the matching process. Referring to FIG. 15, the following step consists in creating spot patterns in the reference image. Here, the objective is to characterize every single identified spot in the reference image by creating a topological graph (pattern), wherein the concept is based on the fact that a spot can be identified by the relative position of its neighboring spots. Hence, for each identified spot in the reference image, a topological graph, which can be viewed as a topological pattern such as a constellation, is constructed and preserved in memory. A spot pattern is composed of nodes, arcs, and a central node. The central node corresponds to the spot of interest (60), the nodes correspond to neighboring spots (62), and the arcs are line segments that join the central node to the neighboring nodes (64). This graph is characterized by the number of nodes it contains, the length of each arc, and the orientation of each arc. Once this type of graph is created for every spot of interest in the reference image, the next step consists in identifying the corresponding patterns in the target image(s) (66) along with their similarity value, with objective of identifying the presence or absence of the spots of interest previously identified in the reference image. This target image pattern identification step first requires defining an analysis window, which constrains the analysis space in the target images. As a corresponding spot in a target image will approximately have a similar location then in a reference image, it is reasonable to define an analysis window of size mW×mW, where W is the reference pattern's bounding box width, and m is a scaling factor, where m>1. Once the window is defined in the target image, various pattern configurations are constructed with the contained spots, where for each configuration a similarity value with respect to the reference pattern is computed. If a target configuration has a similarity value greater than a specified threshold, then the target spot is considered to be matched with the reference spot. The similarity value can be calculated according to the difference in magnitude and orientation of the graph's line segments (arcs). Finally, the last step simply consists of preserving in memory the spot-to-spot correspondence between the reference image and the target images.

Image Data-Mining

Once robust and fully automated spot identification and matching methods are at hand, as described in the present invention, it becomes possible to perform sophisticated object-centric image content data-mining (or object-based image discovery), which provides additional value and knowledge to the analyst.

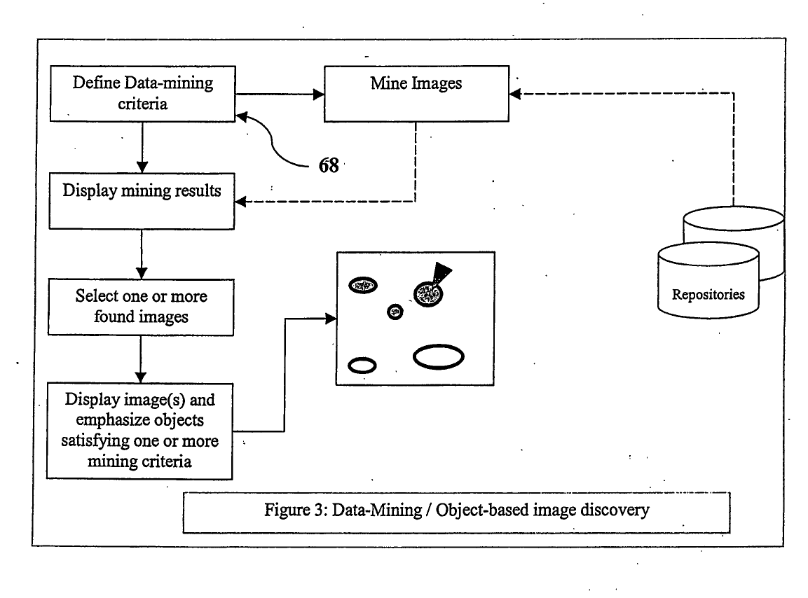

The invention comprises a method for the automated or interactive object-based image data-mining, enabling the discovery of “spot patterns” that are recurrent in a plurality of images, as well as enabling the object-based discovery of images containing specific object properties (morphology, density, area . . . ). Referring to FIG. 3, the method's general operational flow is as follows:

1. Automated spot detection of a first image

2. Data-mining criteria definition

3. Data-mining amongst a plurality of images

4. Results representation

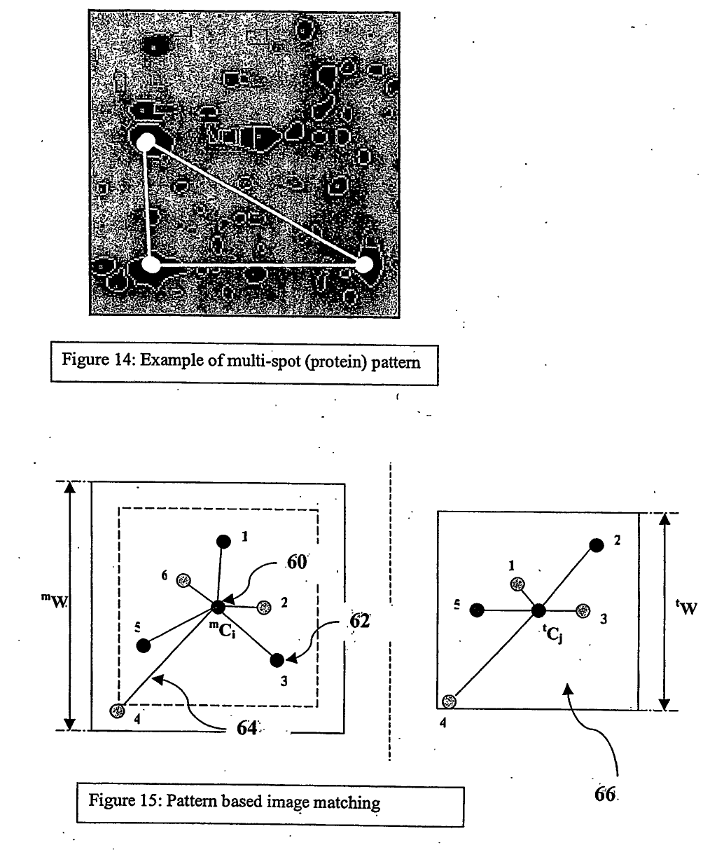

In a specific embodiment, the first step of automated spot detection is achieved using the methods described in the present invention. The second step consists in defining the criteria that will be used for the discovery process (68). A criterion can be for instance a specific pattern of spots that is of interest to a user and who requires identifying other images that may contain a similar pattern. Another criterion can be the number of identifiable spots in an image or any other quantifiable object property. In a specific embodiment, a user interactively defines a pattern of interest by selecting a plurality of previously identified and segmented spots and by defining their topological relation in the form of a graph (FIG. 14). In another embodiment, the graph is defined automatically by the system using a method such as defined in the previous section (image matching). Following the interactive or automated criteria definition, the next step consists in the actual data-mining of images. The data-mining can be conducted on previously segmented images or on never before segmented images. When dealing with non-segmented images, the system requires that these images be analyzed before conducting the data-mining. This can be done for instance on an image-by-image basis, where the system subsequently reads a digital image and identifies the spots therein, performs the data-mining, then repeats the same procedure on N other images.

In a specific embodiment, the present invention comprises one or a plurality of local and/or remote Databases as well as at least one communication interface. The databases may be used for the storage of images, segmentation results, object properties, or image identifiers. The communication interface is used for communicating with computerized equipment over a communication network such as the Internet or an Intranet, for reading and writing data in databases or on remote computers, for instance. The communication can be achieved using the TCP/IP protocols. In a preferred embodiment, the system communicates with two distinct databases: a first database used to store digital images and a second database used to store information and data resulting from the image analysis procedures such as spot identification and segmentation. This second database contains at least information on the source image such as name, unique identifier, location, and the number of identified spots, as well as data on the physical properties of the identified and segmented spots. The latter includes at least the spot spatial coordinates (x-y coordinates), spot surface area, and spot density data. These two databases can be local or remote.

In another embodiment, the system can perform automated spot identification and segmentation on a plurality of images contained in a database or storage medium while the computer on which the system is installed is idle, or when requested by a user. For each processed image, the resulting information is stored in a database as described above. Such automated background processing allows for efficient subsequent data-mining.

The image data-mining process can therefore include object topology and object properties information for the precise and optimal discovery of relations amongst a plurality of images, according to various criteria. In a particular embodiment, a user launches the automated spot identification method on a first image and specifies to the system that every other image contained in the databases that have at least one similar spot topology pattern should be discovered.

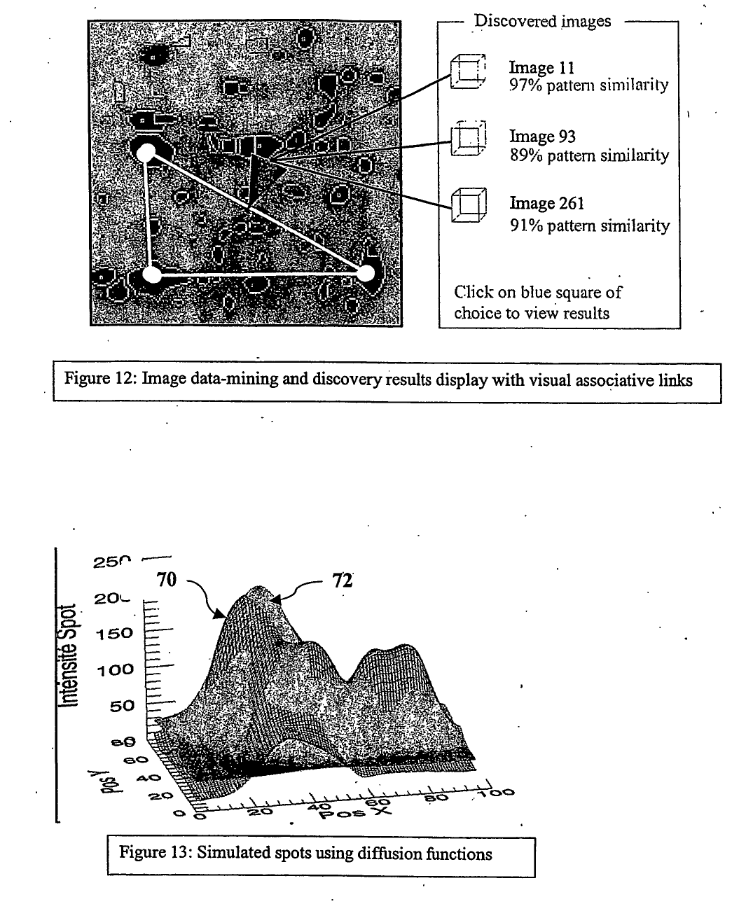

The final step in the data-mining process is the representation of the discovery results. In a preferred embodiment, the results are structured and represented to the user as depicted in FIG. 12, where the list of discovered images based on a pattern search is directly displayed using a visual link.

Semantic Image Classification

Using the previously described methods of spot identification and content-based image data-mining combined to expert knowledge, the system provides the possibility of automatically classifying a set of digital images based on semantic or quantitative criteria. In a specific embodiment, a semantic classification criterion is the protein pattern (signature) inherent to a specific pathology. In this sense, images containing a protein pattern similar to a predefined pathology signature are positively categorized in this specific pathological class. This method comprises 5 main steps:

1. Automated spot identification

2. Pathology signature definition

3. Pattern matching

4. Image categorization

5. Results presentation

The first step of automated spot identification is achieved using the herein described method. The second step consists in defining and associating a protein pattern to a specific pathology. It is this association of a topological pattern to an actual pathology that defines the semantic level of the classification. The definition of a pathology signature is typically defined by the expert user who has explicit knowledge on the existence of a multi-protein signature. The user therefore defines a topological graph using an interactive tool as defined in the image matching section, but further associates this constructed graph to a pathology name. The system thereafter records in permanent storage the graph (graph nodes and arcs with relative coordinates) and its associated semantic name. This stored information is thereafter used to perform the image classification at any time and for building a signature base. This signature base holds a set of signatures that a user may use at any time for performing classification or semantic image discovery. The next step in the process consists in performing image matching by first selecting an appropriate Signature and according reference image. The user then selects a set of images in memory, an image repository or an image database on which the image matching will iteratively be performed. Finally, the user may select a similarity threshold that defines the sensitivity of the matching algorithm. For instance, a User may specify that a positive match corresponds to a signature of 90% or more in similarity to the reference signature. During the image matching process, every positively matched image is categorized in the desired class. Once every considered image has been classified, the results need to be presented. This can be achieved in many ways, such as, without limitation, in the manner depicted in FIG. 12. Referring to FIG. 11, it is also possible to present the results using a Spreadsheet-like view of the information. This spreadsheet can hold information on the name and location of the image positively classified, as will as a link for easy display of the image.

Description as Part of an Embodiment

In the context of the main system that takes into account the various steps required to visualize, analyze and manage the image information, the following describes the embodiment of 2D gel electrophoresis image analysis and management. In this embodiment, there is the possibility of high-throughput automated analysis and management, as well as interactive user driven analysis and management. The following describes both.

User Driven

In the user driven scenario, the first step requires the user to select an image to be analyzed. The user can browse for an image both in standard repositories and in databases using the image loading dialogue, after which the user selects the desired image by clicking the appropriate image name. Following this step, the system loads the chosen image using an image loader. The image loader can read a digital image from a computer system's hard drive and databases, both local and remote to the system. The system can use a communication interface to load images from remote locations through a communication network such as the Internet. Once the image loaded, the system keeps it in memory for subsequent use. The system's display manager then reads the image from memory and displays it in the monitor. The user then activates the image analysis plugin. The image analysis manager loads the considered plugin module and initiates it. This module then automatically analyzes and segments the image (the considered plugin is the analysis and segmentation method herein described). Once the segmentation completed, the results and quantitative parameters are saved by the image information manager in a database or repository in association to its source image. The display manager then displays the image segmentation results by rendering the segmented object's contour's using one or a plurality of different colors. The displayed results are rendered as a new layer on the image. Following the automated analysis, the user can select some external data that is to be associated to portions of the image, the image itself or specific objects of interest. In this embodiment, the external data can be, without limitation, links to web pages for specific protein annotations, mass spectroscopy data, microscopy or other types of images, audio and video information, documents, reports, and structural molecular information. In which case, the user selects any of this information and associates it to the desired regions or objects of interest, by first taking a graphical marker and associating it and positioning it according to the considered objects or regions and thereafter interactively associating this marker with the considered external data. Since the regions or objects of interest have previously been precisely segmented by the segmentation module, their association to the marker is direct and precise: the system automatically detects which region or objects the user has selected and associates the considered pixel values to the marker. In the external data association process, the user defines whether the data should be embedded within the marker or rather associated to it by associative linking.

The user also has the possibility of using the data-mining module for discovering images and patterns. This is achieved by specifying to the system the data-mining criteria, which can be of various nature, such as, without limitation: searching for specific object morphology within images using parameters such as surface area and diameter, searching for objects of specific density, searching for images that contain a specific number of objects, searching for object topological patterns (object constellations), and even search using semantic criteria that describe the nature of the image (a pathology for instance). For instance, the user mines for images that have a specific object topology pattern. The system then displays the results to the user in the monitor. The user can select a specific image and visualize it in the context of the found pattern. The display manager emphasizes the found image's pattern by rendering the considered objects in a different color or by creating and positioning a graphical marker in the context if this pattern. The results can be saved in the current project for later reviewing purposes. The user can further classify a set of images using one or a plurality of the mentioned criteria.

The user can thereafter save the current project along with its associated information. The image, the segmentation results, the graphical markers, and the association to multi-source external data can all be saved in the current project. This allows for the user to reopen an in-progress or completed project and review the contained information.

High Throughput

In the context of high throughput analysis, the system provides a means for efficiently managing the entire workflow. As a first step, a user must select a plurality of folders, repositories, databases, or a specific source from which images can be loaded by the system. In a specific embodiment, the system is automatically and constantly input images originating from a digital imaging system, in which case the system comprises an image buffer that temporarily stores the incoming digital images. The system then reads each image in this buffer one at a time for analysis. Once an image is loaded by the system and put in memory, it is automatically analyzed by the image analysis module, as mentioned in the previous user driven specification. The computed image information is thereafter automatically saved in storage media. For the purpose of spot picking by a robotic system, coordinates and parameters for each detected spot is exported in a standard format so as to allow the robotic system to physically extract each protein on the 2D gel. The spot picker can thereafter read the spot parameters and subsequently physically extract the corresponding proteins in the gel matrix. This process is repeated for every image input to the system. In this embodiment, the current invention can be provided as an integrated system, first providing an imaging device to create a digital image from the physical 2D gel, then providing an image input/output device for outputting the digitized gel image and inputting the latter to the provided image analysis software. The software can further control the robotic equipment so as to optimize the throughput and facilitate the spot picking operation. For instance, the software can directly interact with the spot picker controller device based on the spot parameters output by the image analysis software. Furthermore, with the provided confidence attribution method, wherein each detected protein has a confidence level, it becomes possible to control the automated process by specifying a specific confidence level that should be considered. In this sense, the spot picker can for instance only extract protein spots that have a confidence level greater then 70%. Overall, the herein described invention provides fully automated software methods for the image loading, image analysis and segmentation, as well as automated image and data management.

These above and many other embodiments, while depart from any other embodiment as described, do not depart from the present invention as set forth in the accompanying claims.

1. An image and data management method, comprising the steps of:
displaying an image;
producing, displaying, and positioning at least one graphical marker in at least one context of said image;
selecting at least one external data to associate to at least one of said graphical marker, wherein said external data is selected in one or a plurality of local or remote repositories;
associating at least one of said external data to at least one of said graphical marker and displaying a visual indication of said association; and
saving information in one or a plurality of local or remote repositories, said information comprising at least data defining said association.

2. The method as claimed in claim 1 wherein said context is a region of interest, said region of interest being a user defined region composed of pixel values.

3. The method as claimed in claim 2 wherein defining a region of interest comprises the steps of:
providing a tool to the user for defining said region of interest;
interactively defining contour of said region of interest within said image using said tool, said contour being displayed in said image; and
automatically associating said pixel values of said user defined region to said graphical marker.

4. The method as claimed in claim 1 wherein said context is a region of interest, said region of interest being an automatically defined region composed of pixel values by means of an automated segmentation method.

5. The method as claimed in claim 4 further comprising automatically associating said graphical marker to said pixel values of said automatically defined region.

6. The method as claimed in claim 1 further comprising a means for displaying at least one of said external data.

7. The method as claimed in claim 1 wherein said step of producing, displaying and positioning said graphical marker is achieved automatically by means of a program.

8. A system for analyzing and managing image information, comprising:
image input means for inputting an image;
image analysis program for automatically identifying and quantifying objects of interest within said image, said program producing image information;
association program for associating multi-source information to said image and said objects of interest, said step of associating producing associative information;
display program for displaying said image, at least some of said multi-source information, and for producing and displaying graphical information in context of said objects of interest of said image; and
storage means and program for storing said image, said image information, said graphical information, and said associative information in local or remote repositories.

9. The system as claimed in claim 8, further comprising:
means for automatically searching one or a plurality of said repositories for images that satisfy one or a plurality of data-mining criteria, said data-mining criteria being manually or automatically defined;
means for automatically producing and displaying searching results, said searching results composed of at least a list of found images; and
means for selecting and displaying at least one of said images from said mining results by activating at least one element of said list, wherein said displaying comprises emphasizing said objects of interest of said selected images.

10. A system for providing object-based image discovery, comprising:
image input means for inputting an image;
image analysis program for automatically identifying and quantifying objects of interest within said image, said program producing image information, said image and said image information stored in at least one repository;
a user input means for inputting a discovery criteria;
a searching program for searching within said repositories for images that satisfy said discovery criteria; and
a display means for displaying searching results and said images.

11. A method for automatic spot detection in digital images, comprising the steps of:
reading an image;
computing statistical distribution of noise information in said image;
computing a multiscale analysis level N in accordance to said statistical distribution;
computing a multiscale image of said image up to said level N, and generating at least one type of regionalization of said multiscale image;
identifying objects of interest in said image in correspondence with said multiscale image and said regionalization;
identifying organized structures in said image said organized structures not objects of interest; and
characterizing and classifying said objects of interest.

12. A method for automatically attributing a confidence level to one or a plurality of spot objects in a digital image, comprising the steps of:
reading an image;
automatically identifying spot objects in said image;
computing confidence level of said spot objects; and
displaying confidence level for at least one of said spot objects.

13. A method for characterizing spot objects in an image, comprising:
computing a multiscale representation of said image up to a level N, wherein said step of computing providing a multiscale image;
identifying and defining spot object regions on each of said levels of said multiscale image; and
linking said spot object regions identified on each of said levels of said multiscale image, said linking creating a multiscale event tree, said multiscale event tree providing information for characterizing and classifying said spot objects.

14. The method as claimed in claim 11, wherein said step of characterizing is achieved by
computing a multiscale representation of said image up to a level N, wherein said step of computing providing a multiscale image;
identifying and defining spot object regions on each of said levels of said multiscale image; and
linking said spot object regions identified on each of said levels of said multiscale image, said linking creating a multiscale event tree, said multiscale event tree providing information for characterizing and classifying said spot objects.

15. The method as claimed in claim 11, wherein said step of classifying is achieved by means of an artificial neural network.

16. The method as claimed in claim 11, wherein said organized structures are smear lines.

17. The method as claimed in claim 11, wherein said organized structures are image artifacts, said image artifacts including air bubbles, hair, rips, and scratches.

18. The method as claimed in claim 13, wherein said spot object regions are watershed regions.

19. The method as claimed in claim 4, wherein said automated segmentation method is provided by
computing statistical distribution of noise information in said image;
computing a multiscale analysis level N in accordance to said statistical distribution;
computing a multiscale image of said image up to said level N, and generating at least one type of regionalization of said multiscale image;
identifying objects of interest in said image in correspondence with said multiscale image and said regionalization;
identifying organized structures in said image said organized structures not objects of interest; and
characterizing and classifying said objects of interest.

20. The system as claimed in claim 8, wherein said image analysis program uses the method of
computing statistical distribution of noise information in said image;
computing a multiscale analysis level N in accordance to said statistical distribution;
computing a multiscale image of said image up to said level N, and generating at least one type of regionalization of said multiscale image;
identifying objects of interest in said image in correspondence with said multiscale image and said regionalization;
identifying organized structures in said image said organized structures not objects of interest; and
characterizing and classifying said objects of interest.

21. The method as claimed in claim 12, wherein said step of automatically identifying is achieved by means of the method of
computing statistical distribution of noise information in said image;
computing a multiscale analysis level N in accordance to said statistical distribution;
computing a multiscale image of said image up to said level N, and generating at least one type of regionalization of said multiscale image;
identifying objects of interest in said image in correspondence with said multiscale image and said regionalization;
identifying organized structures in said image said organized structures not objects of interest; and
characterizing and classifying said objects of interest.

22. A method for quantifying identified spot objects, comprising the steps of:
computing one or a plurality of 2D diffusion functions;
fitting said diffusions functions to said identified spot objects by varying parameters of said diffusion functions in order to optimize said fitting, said parameters providing the variance, width and height of said diffusion functions;
simulating and calculating cumulative effect of said identified spot objects by means of said diffusion functions; and
quantifying said identified spot objects without said cumulative effect by means of said diffusion functions.

23. The system as claimed in claim 10, wherein said image analysis program uses the method of
computing statistical distribution of noise information in said image;
computing a multiscale analysis level N in accordance to said statistical distribution;
computing a multiscale image of said image up to said level N, and generating at least one type of regionalization of said multiscale image;
identifying objects of interest in said image in correspondence with said multiscale image and said regionalization;
identifying organized structures in said image said organized structures not objects of interest; and
characterizing and classifying said objects of interest.
